(19) United States
(12) Patent Application Publication
(10) Pub. No.: US 2026/0349998 A1
(43) Pub. Date: Nov. 5, 2026

(54) CODE PROCESSING METHOD, APPARATUS, MEDIUM, DEVICE, AND PRODUCT

(71) Applicant: Beijing Volcano Engine Technology Co., Ltd., Beijing (CN)

(72) Inventors: Yichang Wu, Beijing (CN); Chao Xu, Beijing (CN); Ran Li, Beijing (CN); Yonghong Yu, Beijing (CN); Changwen Chen, Beijing (CN); Rui Xiao, Beijing (CN)

(21) Appl. No.: 19/538,858

(22) Filed: Feb. 12, 2026

(30) Foreign Application Priority Data
Feb. 14, 2025 (CN) 222510170710.7

(51) Int. Cl. G06F 16/242; G06F 16/215

(52) U.S. Cl. CPC G06F 16/2433; G06F 16/215

(57) ABSTRACT

[symbol]

rocessing method and apparatus, a medium, a device, and a product. The method includes: acquiring a first SQL code and position information, where the position information indicates a position in the first SQL code where code completion needs to be performed; determining a first database table referenced by the position where the code completion needs to be performed; determining a first code segment, where the first code segment is obtained according to a second SQL code, the second SQL code includes a SQL code which is historically submitted and references the first database table, and the first code segment includes a name of a field in the first database table and a parameter corresponding to the field; and determining a code used for performing the code completion at the position.

### CROSS-REFERENCE TO RELATED APPLICATION(S)

This application claims priority to Chinese Application No. 202510170710.7 filed Feb. 14, 2025, the disclosure of which is incorporated herein by reference in its entirety.

### TECHNICAL FIELD

The present disclosure relates to the field of data processing technologies, and specifically, to a code processing method, an apparatus, a medium, a device, and a product.

### BACKGROUND

SQL (Structured Query Language) is a programming language used for data query. To achieve the purpose of data query in a database table, a user generally needs to write SQL code to implement data query. At present, with the increase in data volume and the expansion in database scale, a user needs to write a large amount of SQL code to implement more complex data query operations. In the process of writing SQL code, code completion may be automatically performed, that is, a part of code that the user may continue to write subsequently is completed, and code completion may reduce the workload of the user in writing code, thereby improving coding efficiency.

### SUMMARY

The summary is provided so as to introduce the concept in a brief form, and these concepts will be described in detail in the following detailed description. The summary is not intended to identify the key features or necessary features of the claimed technical solution, nor is it intended to limit the scope of the claimed technical solution.

In a first aspect, the present disclosure provides a code processing method, including:
acquiring a first SQL code and position information, the position information indicating a position in the first SQL code where code completion needs to be performed;
determining, according to the first SQL code and the position information, a first database table referenced by the position where the code completion needs to be performed;
determining a first code segment, the first code segment being obtained according to a second SQL code, the second SQL code including a SQL code which is historically submitted and references the first database table, and the first code segment including a name of a field in the first database table and a parameter corresponding to the field; and
determining, according to the first code segment, a code used for performing the code completion at the position.

In a second aspect, the present disclosure provides a code processing apparatus, including:
an acquisition module, configured to acquire a first SQL code and position information, the position information indicating a position in the first SQL code where code completion needs to be performed;
a first determination module, configured to determine, according to the first SQL code and the position information, a first database table referenced by the position where the code completion needs to be performed;
a second determination module, configured to determine a first code segment, the first code segment being obtained according to a second SQL code, the second SQL code including a SQL code which is historically submitted and references the first database table, and the first code segment including a name of a field in the first database table and a parameter corresponding to the field; and
a third determination module, configured to determine, according to the first code segment, a code used for performing the code completion at the position.

In a third aspect, the present disclosure provides a computer-readable medium having a computer program stored thereon, where when the computer program is executed by a processor, the steps of the code processing method provided in the first aspect of the present disclosure are implemented.

In a fourth aspect, the present disclosure provides an electronic device, including:
a memory having a computer program stored thereon; and
a processor, configured to execute the computer program in the memory to implement the steps of the code processing method provided in the first aspect of the present disclosure.

In a fifth aspect, the present disclosure provides a computer program product including a computer program, where when the computer program is executed by a processor, the steps of the code processing method provided in the first aspect of the present disclosure are implemented.

Through the above technical solution, the first database table referenced by the position where the code completion needs to be performed is determined according to the first SQL code and the position information, so that which database table is referenced at the position may be determined, and the first code segment associated with the first database table may be recalled. The first code segment includes the name of the field in the first database table and the parameter corresponding to the field, and the second SQL code is historically submitted, therefore, the first code segment obtained according to the second SQL code may be used for query in the first database table, the name of the field in the first code segment and the parameter corresponding to the field are accurate, and the code completion is performed according to the first code segment.

Other features and advantages of the present disclosure will be described in detail in the following detailed description.

### BRIEF DESCRIPTION OF THE DRAWINGS

The above and other features, advantages, and aspects of the embodiments of the present disclosure will become more apparent in combination with the drawings and with reference to the following part of detailed description. Throughout the drawings, the same or similar reference numbers refer to the same or similar elements. It should be understood that the drawings are schematic, and the components and elements are not necessarily drawn to scale. In the drawings:

FIG. 1 is a flowchart of a code processing method illustrated according to an exemplary embodiment;

FIG. 2 is a flowchart of a method for determining first code record information illustrated according to an exemplary embodiment;

FIG. 3 is a block diagram of a code processing apparatus illustrated according to an exemplary embodiment; and

FIG. 4 shows a schematic structural diagram of an electronic device suitable for implementing the embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth here; on the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that the various steps described in the method implementations of the present disclosure may be executed in different orders and/or in parallel. In addition, the method implementations may include additional steps and/or omit the execution of the steps shown. The scope of the present disclosure is not limited in this respect.

As used herein, the term “include/comprise” and its variants are open-ended inclusions, that is, “include/comprise but not limited to”. The term “based on” is “at least partially based on”. The term “an embodiment” means “at least one embodiment”; the term “another embodiment” means “at least one other embodiment”; the term “some embodiments” means “at least some embodiments”. Relevant definitions of other terms will be given in the following description.

It should be noted that the concepts such as “first” and “second” mentioned in the present disclosure are only used to distinguish different apparatuses, modules or units, and are not used to limit the order or interdependence of the functions performed by these apparatuses, modules or units.

It should be noted that the modifiers of “one” and “multiple” mentioned in the present disclosure are illustrative rather than restrictive, and those skilled in the art should understand that unless otherwise clearly indicated in the context, they should be understood as “one or multiple”.

The names of messages or information exchanged between multiple apparatuses in the implementations of the present disclosure are only for illustrative purposes, and are not intended to limit the scope of these messages or information.

It may be understood that before using the technical solutions disclosed in the embodiments of the present disclosure, the user should be informed of the type, scope of use, use scenarios, etc. of personal information involved in the present disclosure and the authorization of the user should be obtained in an appropriate manner in accordance with relevant laws and regulations.

For example, in response to receiving an active request from a user, prompt information is sent to the user to clearly prompt the user that the requested operation will require access to and use of personal information of the user. In this way, the user may independently choose, according to the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the manner of sending the prompt information to the user, for example, may be the manner of a pop-up window, and the prompt information may be presented in the pop-up window in text. In addition, the pop-up window may also carry a selection control for the user to select “agree” or “disagree” to provide the personal information to the electronic device.

It may be understood that the above process of notifying and acquiring user authorization is only illustrative, and does not constitute a limitation on the implementations of the present disclosure, and other manners that satisfy the relevant laws and regulations may also be applied to the implementations of the present disclosure.

Meanwhile, it may be understood that the data involved in the technical solution (including but not limited to the data itself, acquisition or use of the data) should comply with the requirements of corresponding laws, regulations, and related provisions.

As described in the background, code completion may improve the efficiency of writing code for the user. At present, the code that needs to be completed may be output by a code completion model. For example, SQL code that has been written by the user on a code editing page and metadata information of a database table associated with the SQL code may be input into the code completion model, and the code completion model may perform reasoning according to the input information and output the code that needs to be completed. However, the code completed by using the manner in the related art may be inaccurate. For example, an enumeration value of a field in the metadata information of the database table is incomplete, the metadata information does not include parameter information and key (KEY) information of a complex data type (such as json and struct), data definition language (DDL) information of the database table in the metadata information is not updated in a timely manner, and so on. These problems may cause insufficient contextual information provided to the code completion model, and the intention of the user cannot be accurately inferred, resulting in a model hallucination.

For example, for the code of the function type, taking get_json_object(json_txt, path) as an example, get_json_object( ) is a function in SQL, json_txt is a name of a field in the database table, and path is a parameter of the function, and the parameter path that may be provided by the code completion model is inaccurate. For a conditional expression, taking column=value as an example, value is a parameter of the field column, and the parameter provided by the model may be inaccurate. Taking gender as an example, 0 and 1 are stored in the database table, where 0 represents female and 1 represents male, and the model may provide gender=female, and the value of gender is not the value actually stored in the database table.

In view of this, the present disclosure provides a code processing method, an apparatus, a medium, a device, and a product to improve the accuracy of code completion.

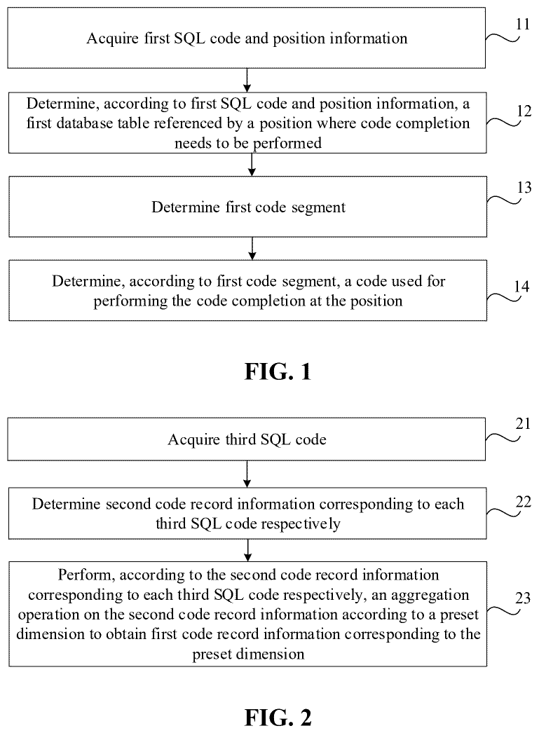

FIG. 1 is a flowchart of a code processing method illustrated according to an exemplary embodiment. The method may be applied to an electronic device with a processing capability, such as a server. As shown in FIG. 1, the method may include steps 11 to 14.

In step 11, a first SQL code and position information are acquired.

The position information indicates a position in the first SQL code where code completion needs to be performed. In an embodiment, a user may write SQL code in an SQL code editor through a client, the first SQL code may be a segment of SQL code currently written by the user in the editor, a cursor may be displayed in the editor, the position of the cursor is the position where the user wants to continue writing code, and the position information may be information of the position of the cursor, which is used to indicate the position where the code completion needs to be performed. The client may send the first SQL code and the position information to the server, and the server may acquire the first SQL code and the position information.

In step 12, a first database table referenced by the position where the code completion needs to be performed is determined according to the first SQL code and the position information.

In an embodiment, the server may generate an abstract syntax tree (AST) corresponding to the first SQL code, and parse the first database table referenced by the position where the code completion needs to be performed based on the AST and the position information. The AST is one of the commonly used data structures for compilers and interpreters that represents the grammatical structure of the program source code, and parses the code into a tree-like structure, where each node represents a grammatical element (such as a statement, an expression, a function, etc.) of the code. Taking the following SQL code 1 as an example, XX represents the position of the cursor, that is, the position where the code completion needs to be performed, and the database table referenced at this position is db.table_a, which may be used as the first database table.
SELECT *
FROM db.table_a AS a
WHERE a.AAXX

In step 13, the first code segment is determined.

The first code segment is obtained according to a second SQL code, the second SQL code includes a SQL code which is historically submitted and references the first database table, the number of the second SQL code may be multiple, and each second SQL code may be a complete segment of SQL code. The second SQL code references the first database table, and there is a code segment associated with the first database table, therefore, the first code segment may be parsed according to the second SQL code, and the first code segment includes a name of a field in the first database table and a parameter corresponding to the field. The second SQL code may be a complete segment of code that is historically submitted and may run normally, therefore, the name of the field and the parameter corresponding to the field obtained from the second SQL code are accurate, and may be used for query in the first database table.

For example, the first code segment parsed from the second SQL code is AA>3, where AA is the name of the field in the first database table, and 3 is the parameter corresponding to the field. According to AA>3, data of the field AA may be queried, therefore, the parameter corresponding to the field is accurate. For example, the first code segment parsed from the second SQL code is BB=10, where BB is the name of the field in the first database table, and 10 is the parameter corresponding to the field BB. Since the second SQL code is historically submitted, there is the parameter 10 in the field BB.

It should be noted that the examples of the SQL code, the example of the first code segment, and the example of the parameter provided in the present disclosure are only for illustration, and do not constitute a limitation on the implementations. For example, in practical applications, the form of the parameter is not limited to the type of number.

In step 14, a code used for performing the code completion at the position is determined according to the first code segment.

In an embodiment, the first code segment and the first SQL code may be input into a pre-trained code completion model, and the code that needs to be completed and that is output by the model is obtained. The first code segment may be used as contextual information and a reasoning basis of the code completion model, so as to provide accurate contextual information for the code completion model, avoid model hallucination, and improve the accuracy of code completion.

In an embodiment, an incomplete part of the position that needs to be completed with respect to the first code segment may be used as the code that needs to be completed. Taking the position that needs to be completed in the above SQL code 1 as an example, for example, if the first code segment is AA>3, then the code that needs to be completed is: >3.

After determining the code used for completion, the server may send the code to the client. In an implementation, the client may directly complete the code, that is, display the code at the position where the code completion needs to be performed. In another implementation, the client may display the code in a code recommendation area as recommendation information, and in response to the user selecting the code, the code is then completed.

Through the above technical solution, the first database table referenced by the position where the code completion needs to be performed is determined according to the first SQL code and the position information, so that which database table is referenced at the position may be determined, and the first code segment associated with the first database table may be recalled. The first code segment includes the name of the field in the first database table and the parameter corresponding to the field, and the second SQL code is historically submitted, therefore, the first code segment obtained according to the second SQL code may be used for query in the first database table, the name of the field in the first code segment and the parameter corresponding to the field are accurate, and the code completion is performed according to the first code segment, so that the problem of inaccuracy of the field name and the parameter corresponding to the field in the code used for completion may be avoided, and the accuracy of code completion may be improved.

The code processing method provided in the present disclosure may further include:
determining first type information according to the first SQL code and the position information, the first type information indicating that the position where the code completion needs to be performed corresponds to a conditional clause or a selection clause.

The selection clause includes a SELECT clause, and the conditional clause includes a WHERE clause, a WHEN clause, a HAVING clause, and other clauses used to define data filtering conditions.

Exemplarily, the server may parse the first type information according to the position information and the AST corresponding to the first SQL code. For example, if the position that needs to be completed is in the SELECT clause, it may be determined that the first type information is used to indicate the selection clause; if the position where the code completion needs to be performed is in the WHERE clause, the CASE WHEN clause, or the HAVING clause, it may be determined that the first type information is used to indicate the conditional clause.

Taking the above SQL code 1 as an example, the position where the code completion needs to be performed corresponds to the WHERE clause, that is, the conditional clause, and it may be determined that the first type information is information used to indicate the conditional clause.

Taking the following SQL code 2 as an example, XX represents the position of the cursor, that is, the position where the code completion needs to be performed, the database table referenced at this position is db.table_b, which may be used as the first database table, and this position corresponds to the SELECT clause, that is, the selection clause, and it may be determined that the first type information is information used to indicate the selection clause.
SELECT get_json_object(json_txt,XX)
FROM db.table_b

In an embodiment, the step of determining the first type information according to the first SQL code and the position information may be executed before step 12, or may be executed after step 12 and before step 13, or may be executed at the same time as step 12, which is not limited.

The step 13 of determining the first code segment may include:
acquiring a candidate code segment corresponding to the field in the first database table, the candidate code segment corresponding to the field including a code segment that references the field and has the same type information as the first type information, and the candidate code segment being obtained according to the second SQL code.

The type information of the code segment indicates that the code segment corresponds to the conditional clause or the selection clause. Exemplarily, the first type information indicates the conditional clause, the first database table includes a field AA and a field BB, the candidate code segment corresponding to the field AA includes, for example, AA>3, AA>5, AA<2, and the candidate code segment corresponding to the field BB includes, for example, BB=10, BB>9, BB>8. Exemplarily, the first type information indicates the selection clause, the first database table includes a field json_txt and a field map, the candidate code segment corresponding to the field json_txt includes, for example, get_json_object(json_txt, path1), get_json_object(json_txt, path2), and the candidate code segment corresponding to the field map includes, for example, map[params1], map[params2].

Then, the first code segment is determined from the candidate code segment corresponding to the field. The first code segment may be determined from candidate code segments corresponding to multiple fields respectively.

In the case that the first type information indicates the conditional clause, the first code segment further includes an SQL operator, the SQL operation refers to a predicate operator used to define a query condition, for example, including >, >=, <, <=, !=, IN, etc. In this case, the first code segment may be a predicate expression. If no function call is performed in the first code segment, the first code segment may include the SQL operator, the name of the field in the first database table, and the parameter corresponding to the field. If a function call exists in the first code segment, the first code segment may include a function name, the SQL operator, the name of the field in the first database table, and the parameter corresponding to the field. For example, the first code segment is COALESCE(condition_name1,“)!=”, the function name is COALESCE, the operator is !=, the name of the field is condition_name1, and the parameter corresponding to the field may be an empty character string.

In the case that the first type information indicates the selection clause and a function call exists in the first code segment, the first code segment further includes a function name. Taking get_json_object(json_txt, path2) as an example, the function name is get_json_object, the name of the field is json_txt, and the parameter corresponding to the field is path2. If the first type information indicates the selection clause, and no function call is performed in the first code segment, the first code segment may include the name of the field and the parameter corresponding to the field. For example, the first code segment is map[params1], map is the name of the field, data stored in the field is of the data type map, and params1 is the parameter corresponding to the field.

The first code segment in the present disclosure may be a complete expression, such as a function expression, which includes the function name, the field name, and the parameter at the same time, for example, a predicate expression, which includes the operator, the field name, and the parameter at the same time, and the reference relationship between the first code segment and the database table is considered, so that the determined first code segment is adapted to the referenced first database table, and the first code segment may represent a complete SQL semantics, and the code used for completion is determined according to the first code segment, thereby improving the accuracy of code completion.

The following describes the process of generating code record information in the present disclosure. FIG. 2 is a flowchart of a method for determining first code record information illustrated according to an exemplary embodiment. As shown in FIG. 2, the method includes steps 21 to 23.

In step 21, a third SQL code is acquired.

The third SQL code may be a SQL code submitted historically, the number of the third SQL code is multiple, and the multiple third SQL codes may include the second SQL code. Each third SQL code may be a complete segment of code that is historically submitted and may run normally.

In step 22, second code record information corresponding to each third SQL code is determined respectively.

An implementation of step 22 may be: for each third SQL code, generating an AST corresponding to the third SQL code, and parsing the AST to obtain the second code record information corresponding to the third SQL code.

For the manner of generating the AST corresponding to the third SQL code, reference may be made to the related art, and the AST may represent structured data in the third SQL code. According to data of each node in the AST, the second code record information corresponding to the third SQL code may be parsed. In the present disclosure, the code record information may include a code segment, type information of the code segment, and a name of a database table referenced by the code segment.

The following Table 1 shows the second code record information corresponding to the third SQL code 1 parsed according to the third SQL code 1 historically submitted by a user 1.

TABLE 1

| Line | | | | Field | User | Department | Project | Submission |
|---|---|---|---|---|---|---|---|---|
| number | Table name | Code segment | Type | name | information | information | information | time |
| 1 | db.table_a | AA > 3 | pre | AA | User 1 | Department 1 | Project 1 | January 2nd |
| 2 | db.table_a | AA > 5 | pre | AA | User 1 | Department 1 | Project 1 | January 2nd |
| 3 | db.table_b | CC < 2 | pre | CC | User 1 | Department 1 | Project 1 | January 2nd |
| 4 | db.table_a | map[params1] | exp | map | User 1 | Department 1 | Project 1 | January 2nd |

The first column represents the line number. The second column represents the name of the database table referenced by the code segment. The third column represents the code segment. The fourth column represents the type information of the code segment, pre represents that the type information indicates the conditional clause, and exp represents that the type information indicates the selection clause. The fifth column represents the name of the field referenced by the code segment. The sixth column represents information of the user 1 who submits the third SQL code 1, for example, identification information (such as a user ID) of the user 1. The seventh column represents information of a business department to which the user 1 belongs, for example, identification information (such as a department name and a department ID) of the business department. The eighth column represents information of a project to which the third SQL code 1 belongs, for example, identification information (such as a project name and a project ID) of the project. The ninth column represents the time when the user 1 submits the third SQL code 1, where the submission time is a date as an example, and specific time such as hour and minute may also be used to represent.

It should be noted that the example of the code record information provided in the present disclosure is only for subsequent illustration, and the information such as the line number, the field name, the user information, the department information, the project information, and the submission time are optional, and are not used to limit that the code record information must include the above information.

The following Table 2 shows the second code record information corresponding to the third SQL code 2 parsed according to the third SQL code 2 historically submitted by the user 1.

TABLE 2

| Line | | | | Field | User | Department | Project | Submission |
|---|---|---|---|---|---|---|---|---|
| number | Table name | Code segment | Type | name | information | information | information | time |
| 1 | db.table_a | AA > 3 | pre | AA | User 1 | Department 1 | Project 2 | January 3rd |
| 2 | db.table_a | BB = 7 | pre | BB | User 1 | Department 1 | Project 2 | January 3rd |
| 3 | db.table_a | get_json_object | exp | json_txt | User 1 | Department 1 | Project 2 | January 3rd |
| | | (json_txt, path1) | | | | | | |

The following Table 3 shows the second code record information corresponding to the third SQL code 3 parsed according to the third SQL code 3 historically submitted by a user 2.

TABLE 3

| Line | | Code | | Field | User | Department | Project | Submission |
|---|---|---|---|---|---|---|---|---|
| number | Table name | segment | Type | name | information | information | information | time |
| 1 | db.table_a | AA > 3 | pre | AA | User 2 | Department 1 | Project 2 | January 4th |
| 2 | db.table_a | AA > 5 | pre | AA | User 2 | Department 1 | Project 2 | January 4th |
| 3 | db.table_a | AA > 9 | pre | AA | User 2 | Department 1 | Project 2 | January 4th |
| 4 | db.table_a | SS < 9 | pre | SS | User 2 | Department 1 | Project 2 | January 4th |

In step 23, according to the second code record information corresponding to each third SQL code respectively, an aggregation operation is performed on the second code record information according to a preset dimension, to obtain first code record information corresponding to the preset dimension.

The aggregation operation includes: aggregating second code record information with a same preset dimension corresponding to different third SQL codes respectively, into one piece of code record information. The preset dimension includes a first preset dimension and/or at least one second preset dimension.

An implementation of performing the aggregation operation according to the first preset dimension is introduced. The first preset dimension includes a code segment and a name of a database table, and the aggregation operation includes aggregating second code record information with both the same code segment and the same name of the database table, into one piece of code record information.

As shown in Table 1, Table 2, and Table 3, the first piece of second code record information (the first row in Table 1) corresponding to the third SQL code 1, the first piece of second code record information (the first row in Table 2) corresponding to the third SQL code 2, and the first piece of second code record information (the first row in Table 3) corresponding to the third SQL code 3 have the code segment of AA>3 and the name of the database table of db.table_a, that is, the first preset dimension of these three pieces of second code record information is the same, and these three pieces of second code record information may be aggregated into one piece of code record information. The following Table 4 shows the result of aggregation according to the first preset dimension, and Table 4 shows the first code record information corresponding to the first preset dimension. As shown in the first piece of first code record information in Table 4, the number of times of use of the code segment AA>3 is 3, and the number of times of use is the number of aggregated second code record information, the number of times of use may also represent the number of times of global use of the code segment AA>3 without distinguishing the user, the department, and the project. The submission time corresponding to the code segment AA>3 is the latest time in the three aggregated second code record information, that is, the submission time of the third SQL code 3.

TABLE 4

| Line | | Code | | Field | Number of | Submission |
|---|---|---|---|---|---|---|
| number | Table name | segment | Type | name | times of use | time |
| 1 | db.table_a | AA > 3 | pre | AA | 3 | January 4th |
| 2 | db.table_a | AA > 5 | pre | AA | 2 | January 4th |
| 3 | db.table_a | AA > 9 | pre | AA | 1 | January 4th |
| 4 | db.table_a | BB = 7 | pre | BB | 1 | January 3rd |
| 5 | db.table_a | SS < 9 | pre | SS | 1 | January 4th |
| 6 | db.table_a | map[params1] | exp | map | 1 | January 2nd |
| 7 | db.table_a | get_json_object | exp | json_txt | 1 | January 3rd |
| | | (json_txt, path1) | | | | |
| 8 | db.table_b | CC < 2 | pre | CC | 1 | January 2nd |

The second piece of second code record information (the second row in Table 1) corresponding to the third SQL code 1 and the second piece of second code record information (the second row in Table 3) corresponding to the third SQL code 3 have the code segment of AA>5 and the name of the database table of db.table_a, the first preset dimension of these two pieces of second code record information is the same, and these two pieces of second code record information are aggregated into one piece of code record information, as shown in the second piece of first code record information in Table 4, where reference may be made to the above explanation for the number of times of use and the submission time in the piece of first code record information.

The other first code record information in Table 4 is not obtained by the aggregation operation, the number of times of use is 1, and the submission time is the submission time of the corresponding third SQL code.

An implementation of performing the aggregation operation according to the second preset dimension is introduced. The second preset dimension includes first code association information, a code segment, and a name of a database table, and the first code association information is one of: information of a first user who submits the third SQL code, information of a business department to which the first user belongs, and information of a project to which the third SQL code belongs.

Taking the first code association information as the information of the first user who submits the third SQL code as an example, as shown in Table 1 and Table 2, the first piece of second code record information (the first row in Table 1) corresponding to the third SQL code 1 and the first piece of second code record information (the first row in Table 2) corresponding to the third SQL code 2 have the code segment of AA>3, the name of the database table of db.table_a, and the user information of the user 1, that is, the second preset dimension of these two pieces of second code record information is the same, and these two pieces of second code record information may be aggregated into one piece of code record information. The following Table 5 shows the result of aggregation according to the second preset dimension, which is the first code record information corresponding to the second preset dimension. As shown in the first piece of first code record information in Table 5, the number of times of use of the code segment AA>3 is 2, which may represent the number of times that the user 1 uses the code segment AA>3. For the manner of determining the submission time, reference may be made to the above introduction. In addition, since only the embodiment of the second code record information corresponding to the third SQL code 3 historically submitted by the user 2 is given, the code record information corresponding to the user 2 in the result shown in Table 5 is not aggregated.

TABLE 5

| Line | | Code | | Field | User | Number of | Submission |
|---|---|---|---|---|---|---|---|
| number | Table name | segment | Type | name | information | times of use | time |
| 1 | db.table_a | AA > 3 | pre | AA | User 1 | 2 | January 3rd |
| 2 | db.table_a | AA > 5 | pre | AA | User 1 | 1 | January 2nd |
| 3 | db.table_a | BB = 7 | pre | BB | User 1 | 1 | January 3rd |
| 4 | db.table_a | map[params1] | exp | map | User 1 | 1 | January 2nd |
| 5 | db.table_a | get_json_object | exp | json_txt | User 1 | 1 | January 3rd |
| | | (json_txt, path1) | | | | | |
| 6 | db.table_b | CC < 2 | pre | CC | User 1 | 1 | January 2nd |
| 7 | db.table_a | AA > 3 | pre | AA | User 2 | 1 | January 4th |
| 8 | db.table_a | AA > 5 | pre | AA | User 2 | 1 | January 4th |
| 9 | db.table_a | AA > 9 | pre | AA | User 2 | 1 | January 4th |
| 10 | db.table_a | SS < 9 | pre | SS | User 2 | 1 | January 4th |

In the present disclosure, the number of the second preset dimension is not limited. For example, the first code association information is information of a business department, and the aggregation operation may be performed according to the information of the business department to obtain the first code record information corresponding to the second preset dimension. For example, the first code association information is information of a project, and the aggregation operation may be performed according to the information of the project to obtain the first code record information corresponding to the second preset dimension. Exemplarily, the code record information with the same code segment, the same name of the database table, and the same project information in Table 2 and Table 3 may be aggregated.

Through the above technical solution, the second code record information with the same preset dimension may be aggregated into one piece of code record information, which may avoid duplicate second code record information with the same preset dimension. In addition, the number of times of use of the code segment and the latest submission time of the code segment in different dimensions may be counted, which may reflect the utilization rate of the code segment, thereby providing a basis for completing the code.

In the present disclosure, the candidate code segment corresponding to the field is obtained by:
acquiring the first code record information, the first code record information being obtained according to a third SQL code submitted historically, the number of the third SQL code being multiple, the multiple third SQL codes including the second SQL code, and the code record information including a code segment, type information of the code segment, and a name of a database table referenced by the code segment; and
determining the candidate code segment corresponding to the field according to the first code record information.

Exemplarily, for example, if the first database table is db.table_a, the above third SQL code 1, third SQL code 2, and third SQL code 3 may also be used as the second SQL code. For example, if the first database table is db.table_b, the third SQL code 1 may be used as the second SQL code.

The code segment, that is, the complete SQL expression, is stored in the first code record information, and the type information of the code segment and the name of the referenced database table are stored in the first code record information, therefore, a code segment that matches the type information of the code that currently needs to be completed and the referenced first database table may be recalled from the first code record information, thereby providing a basis for code completion.

In an implementation, determining the candidate code segment corresponding to the field according to the first code record information may include:
if the preset dimension includes a first preset dimension, using, as third code record information corresponding to the first preset dimension, first code record information that satisfies a first condition and corresponds to the first preset dimension, the first condition including: the name of the database table being a name of the first database table, and the type information of the code segment being the same as the first type information.

Taking the first code record information corresponding to the first preset dimension shown in Table 4 as an example, for example, if the first database table is db.table_a and the first type information indicates the conditional clause, the first five rows of first code record information in Table 4 may be used as the third code record information corresponding to the first preset dimension.

In this way, the code segment in the third code record information matches the first database table and the first type information, and the candidate code segment corresponding to the field is determined according to the third code record information, thereby ensuring that the candidate code segment conforms to the code writing intention of the user.

If the preset dimension includes the second preset dimension, first code record information that satisfies a second condition and corresponds to the second preset dimension is used as third code record information corresponding to the second preset dimension, the second condition including: the name of the database table being the name of the first database table, the type information of the code segment being the same as the first type information, and the first code association information being the same as corresponding second code association information.

The second code association information is one of: information of a second user who writes the first SQL code, information of a business department to which the second user belongs, and information of a project to which the first SQL code belongs. The second code association information may be obtained in advance according to information input by the user. Taking the first code record information corresponding to the second preset dimension shown in Table 5 as an example, the first code association information in the second preset dimension is the information of the first user who submits the third SQL code, and the corresponding second code association information is information of the second user who submits the first SQL code. For example, if the second user is the user 1, the first three rows of first code record information in Table 5 may be used as the third code record information corresponding to the second preset dimension.

In addition, if the aggregation operation is performed according to the information of the business department in advance to obtain the first code record information corresponding to the second preset dimension, the third code record information corresponding to the second preset dimension may be determined by the information of the business department to which the second user belongs. If the aggregation operation is performed according to the information of the project in advance to obtain the first code record information corresponding to the second preset dimension, the third code record information corresponding to the second preset dimension may be determined by the information of the project to which the first SQL code belongs.

In this way, for example, the third code record information that satisfies the condition is determined according to the information of the second user, the code segment historically submitted by the second user may be recalled; the third code record information is determined according to the information of the business department of the second user, the code segment historically submitted by the business department may be recalled; the third code record information is determined according to the information of the project to which the first SQL code belongs, the code segment historically submitted by the project may be recalled. Since these historically submitted code segments are more likely to be reused by the second user currently, and the code segment matches the first database table and the first type information, the candidate code segment may conform to the code writing intention of the user.

Then, the candidate code segment corresponding to the field is determined according to the third code record information. The third code record information further includes the number of times of use of the code segment and/or the submission time of the corresponding third SQL code, where the manner of determining the number of times of use and the submission time has been described above. If sorting is performed only according to the number of times of use, the code segments may be sorted in a descending order according to the number of times of use from more to less, and the code segments with the same number of times of use may be sorted randomly. If sorting is performed only according to the submission time, the code segments may be sorted in a descending order according to the submission time from late to early, and the code segments with the same submission time may be sorted randomly. If sorting is performed according to both the number of times of use and the submission time, the code segments may be sorted in a descending order according to the number of times of use from more to less first, and then sorted in a descending order according to the submission time from late to early for the code segments with the same number of times of use.

In the case that the third code record information corresponds to one preset dimension, code segments that reference the field in the third code record information corresponding to the preset dimension are sorted according to the number of times of use and/or the submission time; if the number of the code segments that reference the field is greater than a first preset number, the first preset number of code segments ranking in top order are used as the candidate code segment corresponding to the field.

Taking the third code record information corresponding to the first preset dimension as an example, referring to the code record information in the first five rows in Table 4, taking the field AA as an example, the code segments that reference the field AA include the code segments in the first three rows. If the first preset number threshold is 2, the code segments AA>3 and AA>5 may be used as the candidate code segment corresponding to the field AA according to the number of times of use. If the first preset number is 4, the code segments AA>3, AA>5, and AA>9 may all be used as the candidate code segment corresponding to the field AA. The manner of determining the candidate code segment of other fields is similar to this.

In the case that the third code record information corresponds to N preset dimensions, if there are duplicate code segments, a deduplication operation is performed, the duplicate code segments are code segments that exist in third code record information corresponding to n preset dimensions respectively at the same time, the deduplication operation includes deleting third code record information of duplicate code segments corresponding to n−1 preset dimensions, N≥2, 2≤n≤N.

The N preset dimensions are set with different priorities, and the n−1 preset dimensions are preset dimensions with lower priorities in the n preset dimensions. For example, the first preset dimension is a global dimension, the second preset dimension includes a user dimension, a business department dimension, and a project dimension, and the priorities may be preset from high to low as follows: user dimension>business department dimension>project dimension>global dimension.

If the third code record information corresponds to multiple preset dimensions, there may be duplicate code segments. Referring to Table 4 and Table 5, the third code record information corresponding to two preset dimensions respectively is included, where the code segments AA>3, AA>5, and BB=7 are duplicate code segments. Taking AA>3 as an example, the preset dimension corresponding to Table 4 has a lower priority, and the third code record information in the first row in Table 4 may be deleted. For example, the code segment AA>3 exists in the third code record information corresponding to the user dimension, the business department dimension, the project dimension, and the global dimension respectively at the same time, and the user dimension has the highest priority, therefore, the third code record information of the code segment AA>3 corresponding to the business department dimension, the project dimension, and the global dimension respectively is deleted, and only the code segment corresponding to the user dimension is retained.

The candidate code segment corresponding to the field is determined according to the third code record information after the deduplication operation, in this way, it may be ensured that there are no duplicate code segments in the third code record information corresponding to different preset dimensions respectively after the deduplication operation.

Exemplarily, determining the candidate code segment corresponding to the field according to the third code record information after the deduplication operation includes:
for each of the N preset dimensions, sorting, according to the number of times of use and/or the submission time, code segments that reference the field in the third code record information after the deduplication operation corresponding to the preset dimension; and
traversing, in an order of the priorities from high to low, the third code record information after the deduplication operation corresponding to the N preset dimensions respectively, extracting, from the third code record information corresponding to a currently traversed preset dimension, a code segment that references the field as the candidate code segment corresponding to the field according to a sorting result of the code segments, until the number of the candidate code segments reaches the first preset number or the third code record information corresponding to the N preset dimensions respectively have been traversed.

Taking the field AA as an example, referring to Table 4, after the deduplication operation, the code segment that references the field AA is AA>9. Referring to Table 5, the code segments that reference the field AA include AA>3 and AA>5, and the sorting result is that AA>3 is before AA>5. The second preset dimension has a higher priority. First, for Table 5, if the first preset number is 1, the candidate code segment corresponding to the field AA is AA>3, and traversing is stopped. If the first preset number is 3, after two candidate code segments are extracted from Table 5, the candidate code segment AA>9 is extracted for Table 4. Taking the field SS as an example, the third code record information in Table 5 does not include a code segment that references the field SS, and the code segment SS<9 may be extracted from Table 4 as the candidate code segment of the field SS.

Through the above technical solution, the candidate code segment corresponding to each field may be determined, and the candidate code segment may be determined according to the number of times of use and/or the submission time. The code segment with more times of use and the code segment with a later submission time are more likely to be reused by the user, therefore, the determined candidate code segment may better meet the requirements of the user, and the accuracy of code completion may be improved.

The following introduces an implementation of determining the first code segment from the candidate code segment corresponding to the field in the present disclosure.

In an embodiment, if there is a written second code segment in the first SQL code, and there is field information at the position where the code completion needs to be performed, the first code segment is determined from code segments other than the second code segment in the candidate code segment corresponding to the field that matches the field information.

Exemplarily, the field information includes all or part of content of a name of the field in the referenced first database table, type information of the second code segment is the same as the first type information, and the referenced database table is the first database table. That is, the second code segment includes one or more written code segments in the first SQL code that reference the first database table and have the type information of the first type information. The server may parse, according to the position information and the AST of the first SQL code, whether there is a written second code segment in the first SQL code and whether there is field information at the position where the code completion needs to be performed. Taking the following SQL code as an example, XX in the SQL code represents the position of the cursor, that is, the position where the code completion needs to be performed.
WHERE a.condition_naXX
AND a.condition_name2<100

There is field information “condition_na” at the position where the code completion needs to be performed, and the field information is part of the name of the field in the first database table. The written second code segment condition_name2<100 exists in the first SQL code. Exemplarily, the field that matches the field information may be a field including the field information, for example, the field that matches the field information “condition_na” may include condition_name1, condition_name2. The first code segment may be determined from code segments other than condition_name2<100 in the candidate code segment corresponding to condition_name2 and the candidate code segment corresponding to condition_name1, for example, all these candidate code segments may be used as the first code segment, or a part of these candidate code segments may be used as the first code segment. Exemplarily, the manner of sorting the code segments is introduced above, and the sorting result may be maintained when the candidate code segments are extracted, for example, a preset number of code segments ranking in top order in other code segments corresponding to condition_name2 may be used as the first code segment, and a preset number of code segments ranking in top order in the candidate code segment corresponding to condition_name1 may be used as the first code segment. The manner of determining the first code segment is not limited.

It should be noted that, taking this SQL code as an example, where, when the user writes a.condition_name2<100, the server may determine the candidate code segment corresponding to the field in the database table db.table_a, for example, the candidate code segment corresponding to the field condition_name1, the candidate code segment corresponding to the field condition_name2, and the candidate code segments corresponding to other fields are included, and the server may cache these candidate code segments. When the code completion needs to be performed currently, the candidate code segment corresponding to the field in the database table db.table_a may be acquired from the cache, without re-executing the steps of determining the candidate code segment corresponding to each field again. If there is no second code segment condition_name2<100 in the SQL code, the server may execute the steps of determining the candidate code segment corresponding to the field in real time. That is, the candidate code segment corresponding to the field may be determined in real time, or may be acquired from the cache.

In an embodiment, if there is field information at the position where the code completion needs to be performed, and there is no written second code segment in the first SQL code, the first code segment is determined according to the candidate code segment corresponding to the field that matches the field information.

Taking the following SQL code as an example, XX in the SQL code represents the position where the code completion needs to be performed.
SELECT get_json_object(json_txt,XX)
FROM db.table_a AS a

There is field information “json_txt” at the position where the code completion needs to be performed, and there is no written second code segment in the first SQL code. For a code segment with a function name, for example, there is a function name get_json_object here, all or part of candidate code segments with the function name in the candidate code segment corresponding to the field json_txt may be used as the first code segment.

In an embodiment, if there is a written second code segment in the first SQL code, and there is no field information at the position where the code completion needs to be performed, the first code segment is determined from code segments other than the second code segment in the candidate code segment.
Taking the following SQL code as an example, XX represents the position where the code completion needs to be performed.
WHERE XX
AND a.condition_name2<100

There is no field information at the position where the code completion needs to be performed, and the written second code segment condition_name2<100 exists in the first SQL code. The first code segment may be determined from code segments other than condition_name2<100 in the candidate code segments corresponding to multiple fields in the database table db.table_a, for example, all or part of the other code segments may be used as the first code segment.

Through the above technical solution, since the user has already written the second code segment and generally does not write it repeatedly, in order to avoid invalid recommendation and completion, the second code segment may not be used as the first code segment. If the user has written the field information at the position that needs to be completed, the first code segment may be determined according to the candidate code segment corresponding to the field that matches the field information, which is more in line with the code writing intention of the user, and the accuracy of code completion is higher.

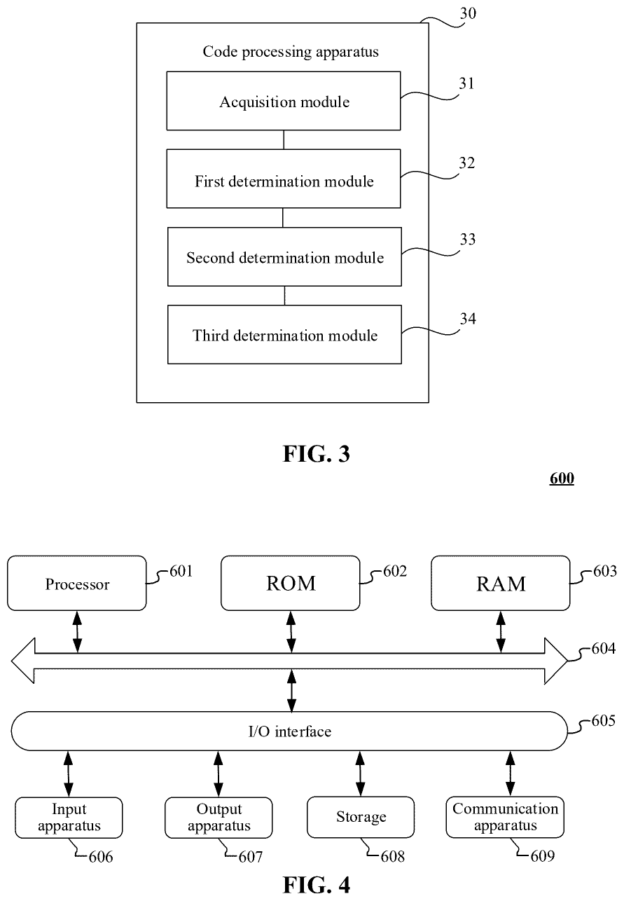

Based on the same inventive concept, the present disclosure further provides a code processing apparatus. FIG. 3 is a block diagram of a code processing apparatus illustrated according to an exemplary embodiment. As shown in FIG. 3, the code processing apparatus 30 may include:
an acquisition module 31, configured to acquire a first SQL code and position information, the position information indicating a position in the first SQL code where code completion needs to be performed;
a first determination module 32, configured to determine, according to the first SQL code and the position information, a first database table referenced by the position where the code completion needs to be performed;
a second determination module 33, configured to determine a first code segment, the first code segment being obtained according to a second SQL code, the second SQL code including a SQL code which is historically submitted and references the first database table, and the first code segment including a name of a field in the first database table and a parameter corresponding to the field; and
a third determination module 34, configured to determine, according to the first code segment, a code used for performing the code completion at the position.

Optionally, the apparatus 30 further includes:
a fourth determination module, configured to determine first type information according to the first SQL code and the position information, the first type information indicating that the position where the code completion needs to be performed corresponds to a conditional clause or a selection clause; and
the second determination module 33 includes:
   a first acquisition sub-module, configured to acquire a candidate code segment corresponding to a field in the first database table, the candidate code segment corresponding to the field including a code segment that references the field and has the same type information as the first type information, and the candidate code segment being obtained according to the second SQL code; and
   a first determination sub-module, configured to determine the first code segment from the candidate code segment corresponding to the field, where, in the case that the first type information indicates the conditional clause, the first code segment further includes an SQL operator, and in the case that the first type information indicates the selection clause and a function call exists in the first code segment, the first code segment further includes a function name.

Optionally, the candidate code segment corresponding to the field is obtained by:
a first acquisition module, configured to acquire first code record information, the first code record information being obtained according to third SQL codes which are historically submitted and the number of which is multiple, the multiple third SQL codes including the second SQL code, and code record information including a code segment, type information of the code segment, and a name of a database table referenced by the code segment; and
a segment determination module, configured to determine the candidate code segment corresponding to the field according to the first code record information.

Optionally, the first code record information is obtained by:
a second acquisition module, configured to acquire the third SQL code;
an information determination module, configured to determine second code record information corresponding to each third SQL code respectively; and
an aggregation module, configured to perform, according to the second code record information corresponding to each third SQL code respectively, an aggregation operation on the second code record information according to a preset dimension to obtain the first code record information corresponding to the preset dimension;
   where the aggregation operation includes: aggregating, into one piece of code record information, the second code record information with a same preset dimension and corresponds to different third SQL codes respectively; and
   the preset dimension includes a first preset dimension and/or at least one second preset dimension, the first preset dimension includes the code segment and the name of the database table, the second preset dimension includes first code association information, the code segment, and the name of the database table, and the first code association information is one of: information of a first user who submits the third SQL code, information of a business department to which the first user belongs, and information of a project to which the third SQL code belongs.

Optionally, the segment determination module includes:
a second determination sub-module, configured to: if the preset dimension includes the first preset dimension, use, as third code record information corresponding to the first preset dimension, first code record information that satisfies a first condition and corresponds to the first preset dimension, the first condition including: the name of the database table being a name of the first database table, and type information of the code segment being the same as the first type information;
a third determination sub-module, configured to: if the preset dimension includes the second preset dimension, use, as third code record information corresponding to the second preset dimension, first code record information that satisfies a second condition and corresponds to the second preset dimension, the second condition including: the name of the database table being the name of the first database table, the type information of the code segment being the same as the first type information, and the first code association information being the same as corresponding second code association information, the second code association information being one of: information of a second user who writes the first SQL code, information of a business department to which the second user belongs, and information of a project to which the first SQL code belongs; and
a fourth determination sub-module, configured to determine the candidate code segment corresponding to the field according to the third code record information.

Optionally, the third code record information further includes the number of times of use of the code segment and/or a submission time of the corresponding third SQL code; and
the fourth determination sub-module includes:
   a fifth determination sub-module, configured to: in the case that the third code record information corresponds to one preset dimension, sort, according to the number of times of use and/or the submission time, code segments that reference the field in the third code record information corresponding to the preset dimension; if the number of the code segments that reference the field is greater than a first preset number, use the first preset number of code segments ranking in top order as the candidate code segment corresponding to the field.

Optionally, the fourth determination sub-module includes:
a processing sub-module, configured to: in the case that the third code record information corresponds to N preset dimensions, if there are duplicate code segments, perform a deduplication operation, the duplicate code segments being code segments that exist in third code record information corresponding to n preset dimensions respectively at the same time, the deduplication operation including deleting third code record information of the duplicate code segments corresponding to n−1 preset dimensions, N≥2, 2≤n≤N, the N preset dimensions being set with different priorities, and the n−1 preset dimensions being preset dimensions with lower priorities in the n preset dimensions; and
a sixth determination sub-module, configured to determine the candidate code segment corresponding to the field according to the third code record information after the deduplication operation.

Optionally, the third code record information further includes the number of times of use of the code segment and/or a submission time of the corresponding third SQL code; and
the sixth determination sub-module includes:
   a sorting sub-module, configured to: for each of the N preset dimensions, sort, according to the number of times of use and/or the submission time, code segments that reference the field in the third code record information after the deduplication operation corresponding to the preset dimension; and
   an extraction sub-module, configured to traverse, in an order of the priorities from high to low, the third code record information after the deduplication operation corresponding to the N preset dimensions respectively, and extract, from the third code record information corresponding to a currently traversed preset dimension, the code segment that references the field as the candidate code segment corresponding to the field according to a sorting result of the code segments, until the number of the candidate code segments reaches a first preset number or the third code record information corresponding to the N preset dimensions respectively have been traversed.

Optionally, the information determination module is configured to:
for each third SQL code, generate an abstract syntax tree corresponding to the third SQL code, and parse the abstract syntax tree to obtain the second code record information corresponding to the third SQL code.

Optionally, the first determination sub-module includes:
a seventh determination sub-module, configured to: if a written second code segment exists in the first SQL code and field information exists at the position where the code completion needs to be performed, determine the first code segment from code segments other than the second code segment in the candidate code segment corresponding to the field that matches the field information, the field information including all or part of content of a name of the field in the first database table which is referenced, and type information of the second code segment being the same as the first type information and a referenced database table being the first database table.

Optionally, the first determination sub-module includes:
an eighth determination sub-module, configured to: if a written second code segment exists in the first SQL code and no field information exists at the position where the code completion needs to be performed, determine the first code segment from code segments other than the second code segment in the candidate code segment, the field information including all or part of content of a name of the field in the first database table which is referenced, and type information of the second code segment being the same as the first type information and a referenced database table being the first database table.

Optionally, the first determination sub-module includes:
a ninth determination sub-module, configured to: if field information exists at the position where the code completion needs to be performed and no written second code segment exists in the first SQL code, determine the first code segment according to the candidate code segment corresponding to the field that matches the field information, the field information including all or part of content of a name of the field in the first database table which is referenced, and type information of the second code segment being the same as the first type information and a referenced database table being the first database table.

Reference is made to FIG. 4 below, which illustrates a schematic structural diagram of an electronic device 600 suitable for implementing the embodiments of the present disclosure. The electronic device shown in FIG. 4 is only an example, and should not impose any limitation to the functions and the range of use of the embodiments of the present disclosure.

As shown in FIG. 4, the electronic device 600 may include a processor (e.g., a central processing unit, a graphics processing unit, etc.) 601, which may perform various appropriate actions and processing according to a program stored in a read-only memory (ROM) 602 or a program loaded from a storage 608 into a random access memory (RAM) 603. In the RAM 603, various programs and data required for operations of the electronic device 600 are also stored. The processor 601, the ROM 602, and the RAM 603 are connected to each other through a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage 608 including, for example, a magnetic tape, a hard disk, etc.; and a communication apparatus 609. The communication apparatus 609 may allow the electronic device 600 to perform wireless or wired communication with other devices to exchange data. Although FIG. 4 shows the electronic device 600 with various apparatuses, it should be understood that it is not required to implement or have all the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 609, or installed from the storage apparatus 608, or installed from the ROM 602. When the computer program is executed by the processor 601, the above-mentioned functions defined in the method of the embodiments of the present disclosure are executed.

It should be noted that the above-mentioned computer-readable medium in the present disclosure may be a computer-readable signal medium, a computer-readable storage medium, or any combination of the two. The computer-readable storage medium may be, for example, but not limited to, an electronic, magnetic, optical, electromagnetic, infrared, or semiconductor system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated on a baseband or as a part of a carrier wave, and computer-readable program code is carried in the data signal. The data signal propagated in this way may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus or device. The program code contained on the computer-readable medium may be transmitted by any suitable medium, including but not limited to: a wire, an optical cable, a radio frequency (RF), etc., or any suitable combination of the above.

In some implementations, the server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above computer-readable medium may be contained in the above electronic device, or may exist alone without being assembled into the electronic device.

The above computer-readable medium carries one or more programs, and when the one or more programs are executed by the electronic device, the electronic device: acquires a first SQL code and position information, the position information indicating a position in the first SQL code where code completion needs to be performed;
determines, according to the first SQL code and the position information, a first database table referenced by the position where the code completion needs to be performed;
determines a first code segment, the first code segment being obtained according to a second SQL code, the second SQL code including a SQL code which is historically submitted and references the first database table, and the first code segment including a name of a field in the first database table and a parameter corresponding to the field; and
determines, according to the first code segment, a code used for performing the code completion at the position.

The computer program code for performing the operations of the present disclosure may be written in one or more programming languages or a combination thereof, the programming languages including but not limited to object-oriented programming languages such as Java, Smalltalk, C++, and including conventional procedural programming languages such as “C” language or similar programming languages. The program code may be executed entirely on a user's computer, partly on the user's computer, as a stand-alone software package, partly on the user's computer and partly on a remote computer, or entirely on the remote computer or server. In the case involving the remote computer, the remote computer may be connected to the user's computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical function. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules involved in the embodiments of the present disclosure may be implemented by software or by hardware. The name of the module does not constitute a limitation on the module itself under certain circumstances, for example, the acquisition module may also be described as “a module for acquiring a first SQL code and position information”.

The functions described above herein may be at least partially performed by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logic device (CPLD), etc.

In the context of the present disclosure, the machine-readable medium may be a tangible medium that may contain or store the program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides a code processing method, including:
acquiring a first SQL code and position information, the position information indicating a position in the first SQL code where code completion needs to be performed;
determining, according to the first SQL code and the position information, a first database table referenced by the position where the code completion needs to be performed;
determining a first code segment, the first code segment being obtained according to a second SQL code, the second SQL code including a SQL code which is historically submitted and references the first database table, and the first code segment including a name of a field in the first database table and a parameter corresponding to the field; and
determining, according to the first code segment, a code used for performing the code completion at the position.

According to one or more embodiments of the present disclosure, Example 2 provides the method of Example 1, the method further including:
determining first type information according to the first SQL code and the position information, the first type information indicating that the position where the code completion needs to be performed corresponds to a conditional clause or a selection clause; and
determining the first code segment includes:
   acquiring a candidate code segment corresponding to the field in the first database table, the candidate code segment corresponding to the field including a code segment that references the field and has the same type information as the first type information, and the candidate code segment being obtained according to the second SQL code; and
   determining the first code segment from the candidate code segment corresponding to the field, where, in the case that the first type information indicates the conditional clause, the first code segment further includes an SQL operator, and in the case that the first type information indicates the selection clause and a function call exists in the first code segment, the first code segment further includes a function name.

According to one or more embodiments of the present disclosure, Example 3 provides the method of Example 2, the candidate code segment corresponding to the field is obtained by:
acquiring first code record information, the first code record information being obtained according to a third SQL code submitted historically, the number of the third SQL code being multiple, the multiple third SQL codes including the second SQL code, and the code record information including a code segment, type information of the code segment, and a name of a database table referenced by the code segment; and
determining, according to the first code record information, the candidate code segment corresponding to the field.

According to one or more embodiments of the present disclosure, Example 4 provides the method of Example 3, the first code record information is obtained by:
acquiring the third SQL code;
determining second code record information corresponding to each third SQL code respectively; and
performing, according to the second code record information corresponding to each third SQL code respectively, an aggregation operation on the second code record information according to a preset dimension to obtain the first code record information corresponding to the preset dimension;
   where the aggregation operation includes: aggregating, into one piece of code record information, the second code record information with a same preset dimension and corresponds to different third SQL codes respectively; and
   the preset dimension includes a first preset dimension and/or at least one second preset dimension, the first preset dimension includes the code segment and the name of the database table, the second preset dimension includes first code association information, the code segment, and the name of the database table, and the first code association information is one of: information of a first user who submits the third SQL code, information of a business department to which the first user belongs, and information of a project to which the third SQL code belongs.

According to one or more embodiments of the present disclosure, Example 5 provides the method of Example 4, determining the candidate code segment corresponding to the field according to the first code record information includes:
if the preset dimension includes the first preset dimension, using, as third code record information corresponding to the first preset dimension, first code record information that satisfies a first condition and corresponds to the first preset dimension, the first condition including: the name of the database table being a name of the first database table, and type information of the code segment being the same as the first type information;
if the preset dimension includes the second preset dimension, using, as third code record information corresponding to the second preset dimension, first code record information that satisfies a second condition and corresponds to the second preset dimension, the second condition including: the name of the database table being the name of the first database table, the type information of the code segment being the same as the first type information, and the first code association information being the same as corresponding second code association information, the second code association information being one of: information of a second user who writes the first SQL code, information of a business department to which the second user belongs, and information of a project to which the first SQL code belongs; and
determining the candidate code segment corresponding to the field according to the third code record information.

According to one or more embodiments of the present disclosure, Example 6 provides the method of Example 5, the third code record information further includes the number of times of use of the code segment and/or a submission time of the corresponding third SQL code; and
determining the candidate code segment corresponding to the field according to the third code record information includes:
   in the case that the third code record information corresponds to one preset dimension, sorting, according to the number of times of use and/or the submission time, code segments that reference the field in the third code record information corresponding to the preset dimension; if the number of the code segments that reference the field is greater than a first preset number, using the first preset number of code segments ranking in top order as the candidate code segment corresponding to the field.

According to one or more embodiments of the present disclosure, Example 7 provides the method of Example 5, determining the candidate code segment corresponding to the field according to the third code record information includes:
in the case that the third code record information corresponds to N preset dimensions, if there are duplicate code segments, performing a deduplication operation, the duplicate code segments being code segments that exist in third code record information corresponding to n preset dimensions respectively at the same time, the deduplication operation including deleting third code record information of the duplicate code segments corresponding to n−1 preset dimensions, N≥2, 2≤n≤N, the N preset dimensions being set with different priorities, and the n−1 preset dimensions being preset dimensions with lower priorities in the n preset dimensions; and
determining the candidate code segment corresponding to the field according to the third code record information after the deduplication operation.

According to one or more embodiments of the present disclosure, Example 8 provides the method of Example 7, the third code record information further includes the number of times of use of the code segment and/or a submission time of the corresponding third SQL code; and
determining the candidate code segment corresponding to the field according to the third code record information after the deduplication operation includes:
   for each of the N preset dimensions, sorting, according to the number of times of use and/or the submission time, code segments that reference the field in the third code record information after the deduplication operation corresponding to the preset dimension; and
   traversing, in an order of the priorities from high to low, the third code record information after the deduplication operation corresponding to the N preset dimensions respectively, and extracting, from the third code record information corresponding to a currently traversed preset dimension, the code segment that references the field as the candidate code segment corresponding to the field according to a sorting result of the code segments, until the number of the candidate code segments reaches a first preset number or the third code record information corresponding to the N preset dimensions respectively have been traversed.

According to one or more embodiments of the present disclosure, Example 9 provides the method of Example 4, determining second code record information corresponding to each third SQL code respectively includes:
for each third SQL code, generating an abstract syntax tree corresponding to the third SQL code, and parsing the abstract syntax tree to obtain the second code record information corresponding to the third SQL code.

According to one or more embodiments of the present disclosure, Example 10 provides the method of Example 2, determining the first code segment from the candidate code segment corresponding to the field includes:
if a written second code segment exists in the first SQL code and field information exists at the position where the code completion needs to be performed, determining the first code segment from code segments other than the second code segment in the candidate code segment corresponding to the field that matches the field information, the field information including all or part of content of a name of the field in the first database table which is referenced, and type information of the second code segment being the same as the first type information and a referenced database table being the first database table.

According to one or more embodiments of the present disclosure, Example 11 provides the method of Example 2, determining the first code segment from the candidate code segment corresponding to the field includes:
if a written second code segment exists in the first SQL code and no field information exists at the position where the code completion needs to be performed, determining the first code segment from code segments other than the second code segment in the candidate code segment, the field information including all or part of content of a name of the field in the first database table which is referenced, and type information of the second code segment being the same as the first type information and a referenced database table being the first database table.

According to one or more embodiments of the present disclosure, Example 12 provides the method of Example 2, determining the first code segment from the candidate code segment corresponding to the field includes:
if field information exists at the position where the code completion needs to be performed and no written second code segment exists in the first SQL code, determining the first code segment according to the candidate code segment corresponding to the field that matches the field information, the field information including all or part of content of a name of the field in the first database table which is referenced, and type information of the second code segment being the same as the first type information and a referenced database table being the first database table.

The above description is only the illustration of the preferred embodiments of the present disclosure and the technical principles employed. Those skilled in the art should understand that the disclosed scope involved in the present disclosure is not limited to the technical solution formed by the specific combination of the above technical features, and should also cover other technical solutions formed by any combination of the above technical features or their equivalent features without departing from the above disclosed concept. For example, the technical solution formed by replacing the above features with the technical features with similar functions disclosed in the present disclosure (but not limited to).

In addition, although the various operations are depicted in a particular order, this should not be understood as requiring these operations to be performed in the particular order shown or in a sequential order. Under certain circumstances, multitasking and parallel processing may be advantageous. Likewise, although the above discussion contains a number of specific implementation details, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the present subject matter has been described in a language specific to structural features and/or method logic actions, it should be understood that the subject matter defined in the appended claims is not necessarily limited to the specific features or actions described above. Conversely, the specific features and actions described above are merely exemplary forms for implementing the claims. Regarding the apparatuses in the above embodiments, the specific manner in which each module performs an operation has been described in detail in the embodiments relating to the method, and will not be detailed herein.

I/We claim:

1. A code processing method, comprising:
acquiring a first SQL code and position information, the position information indicating a position in the first SQL code where code completion needs to be performed;
determining, based on the first SQL code and the position information, a first database table referenced by the position where the code completion needs to be performed;
determining a first code segment, the first code segment being obtained based on a second SQL code, the second SQL code comprising a SQL code which is historically submitted and references the first database table, and the first code segment comprising a name of a field in the first database table and a parameter corresponding to the field; and
determining, based on the first code segment, a code used for performing the code completion at the position.

2. The method of claim 1, further comprising:
determining first type information based on the first SQL code and the position information, the first type information indicating that the position where the code completion needs to be performed corresponds to a conditional clause or a selection clause; and wherein
determining the first code segment comprises:
acquiring candidate code segments corresponding to the field in the first database table, the candidate code segments corresponding to the field comprising a code segment that references the field and has type information that is the same as the first type information, and the candidate code segments being obtained based on the second SQL code; and
determining the first code segment from the candidate code segments corresponding to the field, wherein, in a case that the first type information indicates the conditional clause, the first code segment further comprises an SQL operator, and in a case that the first type information indicates the selection clause and a function call exists in the first code segment, the first code segment further comprises a function name.

3. The method of claim 2, wherein the candidate code segments corresponding to the field are obtained by:
acquiring first code record information, the first code record information being obtained based on third SQL codes submitted historically, a number of the third SQL codes being multiple, the plurality of third SQL codes comprising the second SQL code, and code record information comprising a code segment, type information of the code segment, and a name of a database table referenced by the code segment; and
determining, based on the first code record information, the candidate code segments corresponding to the field.

4. The method of claim 3, wherein the first code record information is obtained by:
acquiring the third SQL codes;
determining second code record information corresponding to each of the third SQL codes respectively; and
performing, based on the second code record information corresponding to each of the third SQL codes respectively, an aggregation operation on the second code record information according to a preset dimension to obtain the first code record information corresponding to the preset dimension;
wherein the aggregation operation comprises: aggregating the second code record information with a same preset dimension in the second code record information corresponding to the different third SQL codes respectively; and
the preset dimension comprises at least one of a first preset dimension or at least one second preset dimension, the first preset dimension comprises the code segment and a name of the database table, the second preset dimension comprises first code association information, the code segment, and the name of the database table, and the first code association information is one of: information of a first user who submits the third SQL codes, information of a business department to which the first user belongs, and information of a project to which the third SQL code belongs.

5. The method of claim 4, wherein determining the candidate code segments corresponding to the field based on the first code record information comprises:
using, in response to the preset dimension comprising the first preset dimension, the first code record information that corresponds to the first preset dimension and satisfies a first condition as third code record information corresponding to the first preset dimension, the first condition comprising: the name of the database table being a name of the first database table, and the type information of the code segment being the same as the first type information;
using, in response to the preset dimension comprising the second preset dimension, first code record information that corresponds to the second preset dimension and satisfies a second condition as third code record information corresponding to the second preset dimension, the second condition comprising: the name of the database table being the name of the first database table, the type information of the code segment being the same as the first type information, and the first code association information being the same as corresponding second code association information, the second code association information being one of: information of a second user who writes the first SQL code, information of a business department to which the second user belongs, and information of a project to which the first SQL code belongs; and
determining the candidate code segments corresponding to the field based on the third code record information.

6. The method of claim 5, wherein the third code record information further comprises a number of usages of the code segment and/or a submission time of the corresponding third SQL code; and
determining the candidate code segment corresponding to the field based on the third code record information comprises:
in a case that the third code record information corresponds to one preset dimension, sorting, based on the number of usages and/or the submission time, the code segments, in the third code record information corresponding to the preset dimension, that reference the field; using, in response to a number of the code segments that reference the field being greater than a first preset number, the first preset number of code segments ranking in top order as the candidate code segment corresponding to the field.

7. The method of claim 5, wherein determining the candidate code segment corresponding to the field based on the third code record information comprises:
performing, in response to there being duplicate code segments, a deduplication operation in a case that the third code record information corresponds to N preset dimensions, the duplicate code segments being code segments that exist simultaneously in the third code record information corresponding to the n preset dimensions respectively, the deduplication operation comprising deleting the third code record information of the duplicate code segments corresponding to the n−1 preset dimensions, N≥2, 2≤n≤N, the N preset dimensions being set with different priorities, and the n−1 preset dimensions being preset dimensions with lower priorities in the n preset dimensions; and
determining the candidate code segment corresponding to the field based on the third code record information after the deduplication operation.

8. The method of claim 7, wherein the third code record information further comprises a number of usages of the code segment and/or a submission time of a corresponding third SQL code; and
determining the candidate code segment corresponding to the field based on the third code record information after the deduplication operation comprises:
sorting, for each of the N preset dimensions and based on the number of usages and/or the submission time, the code segment that reference the field in the third code record information after the deduplication operation corresponding to the preset dimension; and
traversing, in an order of the priorities from high to low, the third code record information after the deduplication operation corresponding to the N preset dimensions respectively, extracting, from the third code record information corresponding to a currently traversed preset dimension, the code segment that references the field as the candidate code segment corresponding to the field based on a sorting result of the code segments, until a number of the candidate code segments reaches a first preset number or the third code record information corresponding to the N preset dimensions respectively have been traversed.

9. The method of claim 4, wherein determining the respective second code record information corresponding to each third SQL code comprises:
generating, for each third SQL code, an abstract syntax tree corresponding to the third SQL code, and parsing the abstract syntax tree to obtain the second code record information corresponding to the third SQL code.

10. The method of claim 2, wherein determining the first code segment from the candidate code segment corresponding to the field comprises:
in response to a written second code segment existing in the first SQL code and field information exiting at the position where the code completion needs to be performed, determining the first code segment from code segments other than the second code segment in the candidate code segment corresponding to a field that matches the field information, the field information comprising all or part of content of a name of the field in the first database table which is referenced, and type information of the second code segment being the same as the first type information and a referenced database table being the first database table.

11. The method of claim 2, wherein determining the first code segment from the candidate code segment corresponding to the field comprises:
determining, in response to a written second code segment existing in the first SQL code and no field information existing at the position where the code completion needs to be performed, the first code segment from code segments other than the second code segment in the candidate code segment, the field information comprising all or part of content of a name of the field in the first database table which is referenced, and type information of the second code segment being the same as the first type information and a referenced database table being the first database table.

12. The method of claim 2, wherein determining the first code segment from the candidate code segment corresponding to the field comprises:
determining, in response to field information existing at the position where the code completion needs to be performed and no written second code segment existing in the first SQL code, the first code segment based on the candidate code segment corresponding to the field that matches the field information, the field information comprising all or part of content of a name of the field in the first database table which is referenced, and type information of the second code segment being the same as the first type information and a referenced database table being the first database table.

13. A non-transitory computer-readable medium having a computer program stored thereon, wherein the computer program, when executed by a processor, causes a computer to:
acquire a first SQL code and position information, the position information indicating a position in the first SQL code where code completion needs to be performed;
determine, based on the first SQL code and the position information, a first database table referenced by the position where the code completion needs to be performed;
determine a first code segment, the first code segment being obtained based on a second SQL code, the second SQL code comprising a SQL code which is historically submitted and references the first database table, and the first code segment comprising a name of a field in the first database table and a parameter corresponding to the field; and
determine, based on the first code segment, a code used for performing the code completion at the position.

14. The non-transitory computer-readable medium according to claim 13, wherein the computer program further causes the computer to:
determine first type information based on the first SQL code and the position information, the first type information indicating that the position where the code completion needs to be performed corresponds to a conditional clause or a selection clause; and wherein
the computer program causing the computer to determine the first code segment further causes the computer to:
acquire candidate code segments corresponding to the field in the first database table, the candidate code segments corresponding to the field comprising a code segment that references the field and has type information that is the same as the first type information, and the candidate code segments being obtained based on the second SQL code; and
determine the first code segment from the candidate code segments corresponding to the field, wherein, in a case that the first type information indicates the conditional clause, the first code segment further comprises an SQL operator, and in a case that the first type information indicates the selection clause and a function call exists in the first code segment, the first code segment further comprises a function name.

15. The non-transitory computer-readable medium according to claim 14, wherein the candidate code segments corresponding to the field are obtained by the computer program causing the computer to:
acquire first code record information, the first code record information being obtained based on third SQL codes submitted historically, a number of the third SQL codes being multiple, the plurality of third SQL codes comprising the second SQL code, and code record information comprising a code segment, type information of the code segment, and a name of a database table referenced by the code segment; and
determine, based on the first code record information, the candidate code segments corresponding to the field.

16. The non-transitory computer-readable medium according to claim 15, wherein the first code record information is obtained by the computer program causing the computer to:
acquire the third SQL codes;
determine second code record information corresponding to each of the third SQL codes respectively; and
perform, based on the second code record information corresponding to each of the third SQL codes respectively, an aggregation operation on the second code record information according to a preset dimension to obtain the first code record information corresponding to the preset dimension;
wherein the aggregation operation comprises the computer program causing the computer to: aggregate the second code record information with a same preset dimension in the second code record information corresponding to the different third SQL codes respectively; and
the preset dimension comprises at least one of a first preset dimension or at least one second preset dimension, the first preset dimension comprises the code segment and a name of the database table, the second preset dimension comprises first code association information, the code segment, and the name of the database table, and the first code association information is one of: information of a first user who submits the third SQL codes, information of a business department to which the first user belongs, and information of a project to which the third SQL code belongs.

17. The non-transitory computer-readable medium according to claim 16, wherein the computer program causing the computer to determine the candidate code segments corresponding to the field based on the first code record information further causes the computer to:
use, in response to the preset dimension comprising the first preset dimension, the first code record information that corresponds to the first preset dimension and satisfies a first condition as third code record information corresponding to the first preset dimension, the first condition comprising: the name of the database table being a name of the first database table, and the type information of the code segment being the same as the first type information;
use, in response to the preset dimension comprising the second preset dimension, first code record information that corresponds to the second preset dimension and satisfies a second condition as third code record information corresponding to the second preset dimension, the second condition comprising: the name of the database table being the name of the first database table, the type information of the code segment being the same as the first type information, and the first code association information being the same as corresponding second code association information, the second code association information being one of: information of a second user who writes the first SQL code, information of a business department to which the second user belongs, and information of a project to which the first SQL code belongs; and
determine the candidate code segments corresponding to the field based on the third code record information.

18. The non-transitory computer-readable medium according to claim 17, wherein the third code record information further comprises a number of usages of the code segment and/or a submission time of the corresponding third SQL code; and
the computer program causing the computer to determine the candidate code segment corresponding to the field based on the third code record information further causes the computer to:
in a case that the third code record information corresponds to one preset dimension, sort, based on the number of usages and/or the submission time, the code segments, in the third code record information corresponding to the preset dimension, that reference the field; use, in response to a number of the code segments that reference the field being greater than a first preset number, the first preset number of code segments ranking in top order as the candidate code segment corresponding to the field.

19. The non-transitory computer-readable medium according to claim 17, wherein the computer program causing the computer to determine the candidate code segment corresponding to the field based on the third code record information further causes the computer to:
perform, in response to there being duplicate code segments, a deduplication operation in a case that the third code record information corresponds to N preset dimensions, the duplicate code segments being code segments that exist simultaneously in the third code record information corresponding to the n preset dimensions respectively, the deduplication operation comprising deleting the third code record information of the duplicate code segments corresponding to the n−1 preset dimensions, N≥2, 2≤n≤N, the N preset dimensions being set with different priorities, and the n−1 preset dimensions being preset dimensions with lower priorities in the n preset dimensions; and
determine the candidate code segment corresponding to the field based on the third code record information after the deduplication operation.

20. An electronic device, comprising:
a memory storing a computer program thereon; and
a processor, configured to execute the computer program in the memory to:
acquire a first SQL code and position information, the position information indicating a position in the first SQL code where code completion needs to be performed;
determine, based on the first SQL code and the position information, a first database table referenced by the position where the code completion needs to be performed;
determine a first code segment, the first code segment being obtained based on a second SQL code, the second SQL code comprising a SQL code which is historically submitted and references the first database table, and the first code segment comprising a name of a field in the first database table and a parameter corresponding to the field; and
determine, based on the first code segment, a code used for performing the code completion at the position.
